(19) United States
(12) Patent Application Publication
(10) Pub. No.: US 2026/0134099 A1
(43) Pub. Date: May 14, 2026

(54) THREAT MODELING USING MACHINE LEARNING AND CONTEXT INFORMATION

(71) Applicant: Snowflake Inc., Bozeman, MT (US)

(72) Inventors: Tadeusz Jargilo, Ruda Slaska (PL); Mariusz Rzasa, Warsaw (PL)

(21) Appl. No.: 18/947,824

(22) Filed: Nov. 14, 2024

(51) Int. Cl. G06F 21/56; G06F 21/55

(52) U.S. Cl. CPC G06F 21/566; G06F 21/552

(57) ABSTRACT

Various example embodiments provide for threat modeling using machine learning models and context information, where a threat model is generated based on a threat model diagram for a target system being analyzed for threat risks/scenarios. For an individual threat model generated, a threat scenario (e.g., each individual threat scenario) described in the individual threat model can be processed (e.g., individually processed) by a plurality of machine learning models to determine a set of generic mitigation labels for the threat scenario, where each generic mitigation label corresponds to a generic mitigation strategy for mitigating the threat scenario. The set of generic mitigation labels for the threat scenario with context information can be processed by one or more large language models to generate a set of specific mitigation labels for the individual threat model, where each specific mitigation label corresponds to a specific mitigation strategy.

### TECHNICAL FIELD

Embodiments described herein relate to threat models and, more particularly, to systems, methods, devices, and instructions for threat modeling a system using one or more machine learning models and context information.

### BACKGROUND

Threat modeling is a critical process in software development and cybersecurity that aims to identify potential security risks and vulnerabilities in systems and applications. Organizations typically employ methodologies such as STRIDE (Spoofing, Tampering, Repudiation, Information Disclosure, Denial of Service, and Elevation of Privilege) developed by MICROSOFT, and RTMP (Rapid Threat Model Prototyping) to generate templates for threat scenarios.

### BRIEF DESCRIPTION OF DRAWINGS

Various ones of the appended drawings merely illustrate various example embodiments of the present disclosure and should not be considered as limiting its scope. In the drawings, which are not necessarily drawn to scale, like numerals may describe similar components in different views. To easily identify the discussion of any particular element or act, the most significant digit or digits in a reference number refer to the figure number in which that element is first introduced.

FIG. 1 illustrates an example high-level system architecture illustrating an example of a computing environment including a machine learning-based context-aware threat modeling system embodying circuits, controllers, computing devices, data stores, communication infrastructure (e.g., network connections, protocols, etc.), or the like that implement operations described herein, according to some example embodiments of the present disclosure.

FIG. 2 illustrates an example computing environment comprising a database system in the example form of a network-based database system that includes a machine learning-based context-aware threat modeling system, according to some example embodiments of the present disclosure.

FIG. 3 is a block diagram illustrating components of a compute service manager, according to some example embodiments of the present disclosure.

FIG. 4 is a block diagram illustrating components of an execution platform, according to some example embodiments of the present disclosure.

FIG. 5 is a flowchart of an example method for threat modeling a target system using one or more machine learning models and context information, according to some example embodiments of the present disclosure.

FIG. 6 is a diagram illustrating an example data flow for a machine learning-based context-aware threat modeling system, according to some example embodiments of the present disclosure.

FIG. 7 illustrates an example threat model graph that can be received or generated by a machine learning-based context-aware threat modeling system, according to some example embodiments of the present disclosure.

FIG. 8 illustrates an example of specific mitigation labels being determined according to some example embodiments of the present disclosure.

FIG. 9 illustrates an example graphical user interface presented by a machine learning-based context-aware threat modeling system for generating a threat model diagram, according to some example embodiments of the present disclosure.

FIG. 10 illustrates an example graphical user interface presented by a machine learning-based context-aware threat modeling system for reviewing a set of threat scenarios generated in an initial threat model, according to some example embodiments of the present disclosure.

FIG. 11 illustrates an example graphical user interface presented by a machine learning-based context-aware threat modeling system for reviewing a set of threat scenarios of a threat model with specific mitigation labels included or inserted, according to some example embodiments of the present disclosure.

FIG. 12 illustrates a diagrammatic representation of a machine in the form of a computer system within which a set of instructions can be executed for causing the machine to perform any one or more of the methodologies discussed herein, according to some example embodiments of the present disclosure.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Traditionally, the process of threat modeling has been manual, time-consuming, and prone to errors. In current practice, engineers (e.g., developers) often create architecture diagrams and manually fill in threat scenarios using a structured format such as Gherkin syntax. Gherkin is a framework used to write test scenarios or project documentation in a plain-text language and in human-readable format (e.g., in natural language). Traditional threat modeling heavily relies on individual engineer (e.g., developer) knowledge regarding proper security measures and best practices, which can lead to inconsistent quality of threat models. As a result, extended reviews of threat models by security partners and security engineers are often necessary. Overall, traditional threat modeling can be a time-consuming process (e.g., 1-2 hours for a developer to create architecture diagrams and fill in threat scenarios for each threat model, for example using Gherkin syntax), can lack standardization (e.g., entity names across multiple threat models are often not unified, leading to unnecessary analysis and potential duplication of security mechanisms), can have inconsistent quality (e.g., varying levels of thoroughness and accuracy in threat models due to reliance on individual developer knowledge), and can involve resource-intensive reviews (e.g., security engineers spend a significant amount of time reviewing, validating threat models, and participating in a feedback process with the developer). Additionally, traditional threat modeling has limited scalability; generally, traditional threat modeling becomes increasingly difficult to scale as organizations grow and the number of changes requiring security reviews increases. Unfortunately, conventional solutions for improving threat modeling, such as the generation of templates with threat scenarios, still involve manual steps by engineers (e.g., developers) and leave room for human error and inconsistency.

Various example embodiments described herein cure these and other deficiencies of conventional threat modeling solutions. In particular, various example embodiments provide for threat modeling using machine learning models and context information, where a threat model is generated using a threat scenario analysis (e.g., STRIDE analysis), threat scenario prototyping (e.g., RTMP), or both to generate one or more threat models (e.g., template threat models) based on a threat model diagram (e.g., threat model graph) for a target system (e.g., target software-implemented system) being analyzed for threat risks/scenarios. Depending on the example embodiment, a single threat model can be generated to comprise (e.g., cover or describe) one or more threat scenarios (e.g., one or more threat scenarios for each individual process-related data flow of the target system), or multiple threat models can be generated (e.g., each one comprising a single threat scenario). Accordingly, a threat model generated by an example embodiment can comprise a sum of all threat scenarios applicable for all process-related data flows in a given threat model diagram (e.g., given threat model architecture diagram). A given data flow of a system can be associated with multiple threat scenarios, where the multiple threat scenarios are described in a single threat model or across multiple threat models. For an individual threat model generated, a threat scenario (e.g., each individual threat scenario) described in the individual threat model can be processed (e.g., individually processed) by a plurality of machine learning models to determine a set of generic mitigation labels for the threat scenario, where each generic mitigation label corresponds to a generic mitigation strategy (e.g., mitigation solution or mechanism, such as access control or encryption) for mitigating the threat scenario. Then, the set of generic mitigation labels with context information (e.g., an organization's internal or proprietary technical or engineering documents (e.g., technical documents), security guidelines (e.g., policies or standards), definitions of entities in the target system, etc.) can be processed by one or more large language models (LLMs) to generate a set of specific mitigation labels for the individual threat model, where one or more LLMs can implement a RAG (Retrieval-Augmented Generation) technique to pull in as input at least some of the context information (e.g., thereby retrieving real-time or up-to-date organization information), and where each specific mitigation label (e.g., context-aware mitigation label) corresponds to a specific mitigation strategy (e.g., mitigation solution or mechanism) based on the context information. The machine learning models can be used to classify the individual threat model for generic mitigation labels, and the one or more LLMs can be used with context information (e.g., for an engineer's organization) to determine specific mitigation labels for actual, context-aware mitigation strategies. For example, the machine learning models can be used to suggest one or more labels for each scenario, and the one or more LLMs can be used with context information to determine specific mitigation labels from the suggested one or more labels. Eventually, an engineer (e.g., developer or security engineer who created the threat model diagram) can review the set of specific mitigation labels prior to any specific mitigation labels from the set of specific mitigation labels being entered into the individual threat model. For example, the engineer (e.g., developer or security engineer) can review the set of specific mitigation labels and accept (or accept with modification) one or more of the specific mitigation labels, which can cause the accepted mitigation labels to be entered into or included by the individual threat model (e.g., entered/included in the mitigation strategy portion or section of the individual threat model).

As used herein, a system can comprise one or more software components, one or more hardware components, or a combination of both. For example, a system can comprise two or more entities, such as physical or virtual computing devices (e.g., server and client computing devices) communicating over a network, and one or more processes implemented by software residing on one or more of the entities. A target system, as used herein, can refer to a system targeted for threat analysis and target modeling (e.g., by a developer or a security engineer). The target system can comprise a sub-system that forms part of a larger system.

As used herein, a threat model for a system can comprise a data object that uses a structured natural language, such as Gherkin or the like, to describe a set of applicable threat scenarios (e.g., multiple threat scenarios) for the system (e.g., one or more threat scenarios for each data flow of the system) and to describe a set of mitigation strategies for these threat scenarios. A threat model can represent a written framework for identifying and assessing security risks in a system (e.g., a software-implemented system being targeted for analysis). Generally, a threat model can comprise structured content, including descriptions of a system's components, potential threats, vulnerabilities, and attack vectors, as well as the relationships between them. The written content of a threat model can outline one or more specific scenarios, associated risks, and mitigation strategies, serving as a documented blueprint for analyzing how the system may be compromised and how to address those threats. In this way, a threat model can enable a systematic and structured approach to identifying, analyzing, and assessing potential security threats, vulnerabilities, and attack vectors to a system, application, or network. As used herein, a threat scenario analysis system (or process) can include a system (or process) that implements STRIDE analysis methodology. A threat scenario analysis system (or process) can be implemented using one or more scripts and one or more analysis rules.

As used herein, a threat model diagram can comprise any diagram, such as a graph, that can describe at least a portion of a target system to be analyzed for threat modeling. For example, a threat model diagram can describe and visually represent one or more entities of a target system (e.g., physical or virtual computing devices or a component) and one or more data flows between two or more of the entities, where the data flow can be associated with (e.g., caused by) a process (e.g., software-based process) of the target system, where at least one of the data flows is to be analyzed for threat modeling (e.g., for generation of one or more threat models for the system.

As used herein, data flow of a system can refer to a data flow between at least two entities of the system. Each data flow of the system can be associated with a process of the system. A process-related data flow can refer to a data flow of a system that is associated with a process of the system.

As used herein, a large language model (LLM) can include, without limitation, a GPT model (e.g., GPT-4), a LLAMA model (e.g., LLAMA-2), a MISTRAL model, a Claude model (e.g., Claude 3) or another type of generative model (e.g., a proprietary or tailored, generative pre-trained transformer). In some instances, a LLM comprises one or more transformer neural networks, which can be configured (e.g., trained) for general-purpose language generation or another natural language processing task.

Overall, various example embodiments described herein can save time compared to conventional threat model processes, can provide standardization within threat models, can provide threat models with consistent quality, and can avoid resource-intensive reviews. In particular, use of some example embodiments described herein can provide for an efficient and accurate threat modeling process (e.g., can reduce the time and effort for the engineers (e.g., developers) to create threat models and the time and effort for security engineers to review them). Various example embodiments streamline threat modeling workflow, improve consistency, reduce the time and effort required from both developers and security engineers, or some combination thereof. Threat modeling provided by various example embodiments described herein can handle systems (e.g., software-implemented systems) as they increase in complexity and the threat landscape evolves, thereby assisting in maintaining the overall security of the systems.

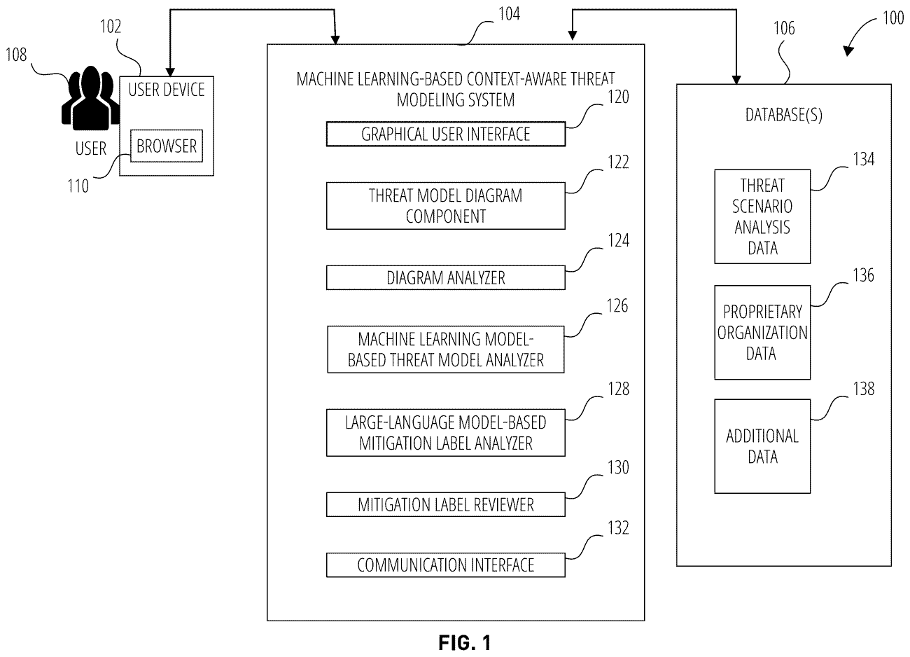

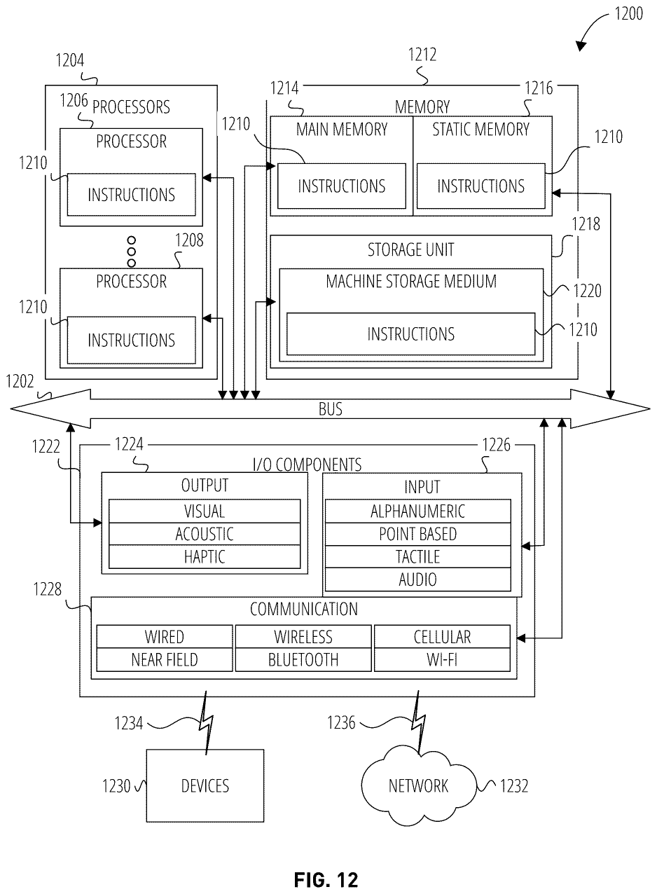

FIG. 1 is an example high-level system architecture illustrating an example of a computing environment 100 including a machine learning-based context-aware threat modeling system 104 embodying circuits, controllers, computing devices, data stores, communication infrastructure (e.g., network connections, protocols, etc.), or the like that implement operations described herein, according to some example embodiments of the present disclosure. One or more components of the machine learning-based context-aware threat modeling system 104 can be implemented using machine 1200 as described herein with respect to FIG. 12.

As utilized herein, circuits, controllers, computing devices, components, modules, or other similar aspects set forth herein should be understood broadly. Such terminology is utilized to highlight that the related hardware devices can be configured in a number of arrangements, and include any hardware configured to perform the operations herein. Any such devices can be a single device, a distributed device, and/or implemented as any hardware configuration to perform the described operations. In certain embodiments, hardware devices can include computing devices of any type, logic circuits, input/output devices, processors, sensors, actuators, web-based servers, LAN servers, WLAN servers, cloud computing devices, memory storage of any type, and/or aspects embodied as instructions stored on a computer-readable medium and configured to cause a processor to perform recited operations. Communication between devices, whether inter communication (e.g., a user device 102 communicating with machine learning-based context-aware threat modeling system 104) or intra-device communication (e.g., one circuit or component of the machine learning-based context-aware threat modeling system 104 communicating with another circuit or component of the machine learning-based context-aware threat modeling system 104) can be performed in any manner, for example using internet-based communication, LAN/WLAN communication, direct networking communication, Wi-Fi communication, or the like.

According to various example embodiments, the machine learning-based context-aware threat modeling system 104 is configured to generate one or more threat models using one or more machine learning models and context information. As shown, the machine learning-based context-aware threat modeling system 104 comprises a graphical user interface 120, a threat model diagram component 122, a diagram analyzer 124, an ML model-based threat model analyzer 126, a large language model (LLM)-based mitigation label analyzer 128, a mitigation label reviewer 130, and a communication interface 132. A user 108 at the user device 102 can access the machine learning-based context-aware threat modeling system 104 and use the machine learning-based context-aware threat modeling system 104 to generate one or more threat models using one or more machine learning models and context information. For example, the user 108 can use a browser 110 on the user device 102 to access the machine learning-based context-aware threat modeling system 104 and as part of the access, the graphical user interface 120 of the machine learning-based context-aware threat modeling system 104 can cause presentation of one or more graphical user interfaces on the user device 102 (e.g., on the browser 110). The user 108 can represent a user an engineer (e.g., developer) associated with an organization (e.g., company) involved in the development or one or more changes to a system, such as a software-implemented system, and intends to generate one or more threat models in association with the development/changes. For example, the user 108 can log into the machine learning-based context-aware threat modeling system 104, use a graphical user interface to submit, generate (e.g., draft), or cause generation of a threat model diagram (e.g., threat model graph) for a target system, and cause the machine learning-based context-aware threat modeling system 104 to generate one or more threat models for the target system based on the threat model diagram.

According to various example embodiments, the threat model diagram component 122 enables or facilitates generation (e.g., creation) of a diagram of a threat model, such as a threat model graph, where the diagram can represent a target system (or a portion of the target system) that is being analyzed for threat modeling (e.g., generation of one or more threat models for one or more data flows of the target system). For example, through a graphical user interface (e.g., 120), the user 108 (e.g., an engineer, such as a developer) can draft (e.g., draw) a diagram of the threat model by adding one or more entities of a target system to the diagram and at least one data flow, associated with a process of the target system, between two entities of the target system. For some example embodiments, the threat model diagram comprises a threat model graph, which comprises one or more nodes that each represent an entity (e.g., a physical or virtual computing device or a component) of the target system and one or more edges that each represent a data flow between two entities in association with a process of the target system. A threat model diagram generated by the threat model diagram component 122 can be stored on one or more databases 106.

For various example embodiments, the diagram analyzer 124 enables or facilitates analysis of the threat model diagram and generation of one or more threat models for the system based on the threat model diagram (e.g., threat model graph). For some example embodiments, the diagram analyzer 124 uses a threat scenario analysis system, such as ones that uses STRIDE analysis system and RTMP-based analysis system, to analyze one or more process-related data flows of the threat model diagram and generates one or more threat models for the one or more process-related data flows based on the analysis. In particular, for some example embodiments, the diagram analyzer 124 generates one or more threat scenarios for each process-related data flow of the target system, where there can be more than one threat scenario for each process-related data flow based on STRIDE methodology and RTMP (to limit the list of threat scenarios generated by STRIDE to only those that are applicable [e.g., using rules that remove some of the STRIDE threat scenarios]). The one or more threat models generated by the diagram analyzer 124 can represent initial or template threat models, each of which can describe one or more threat scenarios. Depending on the example embodiment, each of the one or more threat models is written in structured natural language, such as Gherkin, which can be used to describe one or more threat scenarios and one or more mitigation strategies of the one or more threat scenarios.

For some example embodiments, the ML model-based threat model analyzer 126 enables or facilitates determination of one or more generic mitigation labels at least one threat scenario (e.g., for each individual threat scenario) described in the individual threat model using multiple machine learning models. According to some example embodiments, each generic mitigation label corresponds to a generic mitigation strategy, such as encryption, access control, multi-factor authentication, and the like. A generic mitigation strategy can be considered one that does not take into account context information associated with an organization (e.g., company) that owns, controls, or uses the target system, such as specific engineering documents (e.g., technical documents), security guidelines (e.g., policies or standards), or tools of the organization. For some example embodiments, the ML model-based threat model analyzer 126 uses multiple machine learning models by inputting an individual threat scenario (e.g., described in the individual threat model (from the one or more threat models generated by the diagram analyzer 124) into each individual machine learning model of the multiple machine learning models. The individual threat scenario can comprise a threat category associated with the individual threat scenario (e.g., one of the STRIDE threat categories), a threat name, a threat or risk description, a mitigation strategy for addressing the individual threat scenario, and the like. In addition to inputting the individual threat scenario into each machine learning model of multiple machine learning models, the ML model-based threat model analyzer 126 cam input a description of the data flow (e.g., description of two nodes and the edge between from the threat model diagram) and additional information from threat model diagram, such as trust zone and direction of data flowing. Each individual machine learning model can be configured to output a determination (e.g., indication) of whether to include an individual mitigation label associated with the individual machine learning model in (e.g., a mitigation strategy section of) a respective threat model (e.g., the individual machine learning model) received as input by the individual machine learning model. For some example embodiments, one or more of the machine learning models each comprise a Gradient Boosting Machine (GBM) model. The training of an individual machine learning model (of the multiple machine learning models) using at least portions of one or more existing threat models as training data. The one or more existing threat models used as training data can comprise threat scenarios with associated generic or specific mitigation labels (e.g., in the mitigation strategy portion of the threat models), where the specific mitigation labels can correspond to one or more mitigation strategies specific to the organization associated with the target system. Additionally, each specific mitigation label can provide additional details regarding the one or more mitigation strategies that should be used, including why those mitigation strategies should be used. An individual machine learning model (of the multiple machine learning models) can be associated with a select generic mitigation label, and each machine learning model in the multiple machine learning models can be associated with a different generic mitigation label. Accordingly, an individual machine learning model can be trained to predict its respective generic mitigation label based on input features, such as entity names (e.g., node names), trust zones associated with entities (e.g., nodes), and threat scenarios derived from threat scenario analysis methodologies (such as STRIDE and RTMP). For example, a machine learning model of the multiple machine learning models can be trained on a dataset where the input features include information about a “database” entity (e.g., node) in a “private network” trust zone, with a potential “information disclosure” threat scenario. The machine learning model could learn to associate these features with a relevant, generic mitigation label such as “implement encryption at rest” or “enforce access controls.”

For various example embodiments, an output generated by an individual machine learning model of the plurality of machine learning models comprises a determination of whether a generic mitigation label associated with the individual machine learning model (e.g., one for which the individual machine learning model is trained to detect) should be included in the select threat model with respect to the individual threat scenario. For example, the output comprises the generic mitigation label when the individual machine learning model determines that the generic mitigation label should be included in the individual machine learning model, and does not comprise the generic mitigation label when the individual machine learning model determines that the generic mitigation label should not be included in the individual machine learning model. Additionally, for some example embodiments, an output generated by an individual machine learning model of the plurality of machine learning models comprises a confidence score for the determination (e.g., ranging in value from 0.00 to 1.00). During operation 508, outputs from multiple machine learning models of the plurality of machine learning models can be received (e.g., collected) as a plurality of determinations outputs, and the processor can determine the set of generic mitigation labels from a plurality of determinations outputs by the plurality of machine learning models based on a confidence score threshold (e.g., a confidence score threshold of 0.75). Depending on the example embodiment, the confidence score threshold can differ between applications, organizations, and users, and can be determined (e.g., manually entered) by a user (e.g., engineer).

According to various example embodiments, the LLM-based mitigation label analyzer 128 enables or facilitates processing of the one or more generic mitigation labels (e.g., determined by the ML model-based threat model analyzer 126) to determine one or more specific mitigation labels for the individual threat scenario described in the individual threat model. In particular, the LLM-based mitigation label analyzer 128 can generate (or causes the generation of) a prompt to be submitted to one or more LLMs (e.g., submitted to multiple LLMs in parallel, to a chain of LLMs, or some combination thereof) for generation of output, where the prompt is generated based on a set of inputs that comprises the one or more generic mitigation labels. According to some example embodiments, each specific mitigation label corresponds to a specific, context-aware mitigation strategy, such as encryption methodology, access control methodology, or multi-factor authentication methodology specific to an organization (e.g., the engineer's organization) that owns, controls, or uses the target system. For instance, a specific mitigation strategy can be considered one that takes into account context information associated with the organization (e.g., company), such as specific engineering documents (e.g., technical documents), security guidelines (e.g., policies or standards), or tools of the organization. Accordingly, for some example embodiments, the set of inputs comprises one or more of: a set of security guidelines (e.g., organization's security guidelines); a set of engineering documents; and a set of entity definitions (e.g., node definitions) for one or more entities described in the threat model diagram (e.g., nodes included by the threat model graph). Other data sources for contextual information can include, for example, information posted to internal websites, prior threat models, code repositories, and the like.

For various example embodiments, the mitigation label reviewer 130 enables or facilitates review of the one or more specific mitigation labels (determined for the individual threat scenario described in the individual threat model by the LLM-based mitigation label analyzer 128) by the user 108 (e.g., an engineer, such as a developer or a security engineer). For example, the mitigation label reviewer 130 can cause the one or more specific mitigation labels to be presented (e.g., displayed) to the user 108 via graphical user interface (e.g., 120), where the user 108 can either accept one or more of the specific mitigation labels as presented, accept one or more of the specific mitigation labels after modification by the user 108, or reject one or more of the specific mitigation labels. Depending on example embodiment, acceptance of one or more specific mitigation labels (with or without modification) can cause those accepted specific mitigation labels to be included (e.g., inserted into) the individual threat model (e.g., a mitigation strategy section or portion of the individual threat model that corresponds to the individual threat scenario). Additionally, an example embodiment can store (e.g., collect or log) any modifications made to one or more specific mitigation labels by the user 108 as training data to be used to train (e.g., retrain) one or more machine learning models used by the ML model-based threat model analyzer 126.

For some example embodiments, the communication interface 132 enables or facilitates transmission of individual threat scenario described in the individual threat model with the one or more accepted specific mitigation labels to another system, or transmission of the one or more accepted specific mitigation labels to another system. For example, the communication interface 132 can cause the individual threat model or the one or more accepted specific mitigation labels (for individual threat scenario described in the individual threat model) to be inserted into a new task (e.g., to-do or ticket) on a development system (e.g., new JIRA ticket), where the new task is assigned to the user 108 (e.g., the engineer who drafted or submitted the threat model diagram) for implementation or consideration.

The one or more databases 106 stores data to implement or support of one or more features of the machine learning-based context-aware threat modeling system 104. For example, the one or more databases 106 can store or provide access to threat scenario analysis data 134 (such as STRIDE analysis-related data, RTMP-related data, and the like), proprietary organization data 136 (such as engineering documents, security guidelines, environment tools, and the like), and additional data 138 (such as storage of user modifications to one or more specific mitigation labels, which can be used for subsequent training of one or more of the machine learning models used by the ML model-based threat model analyzer 126).

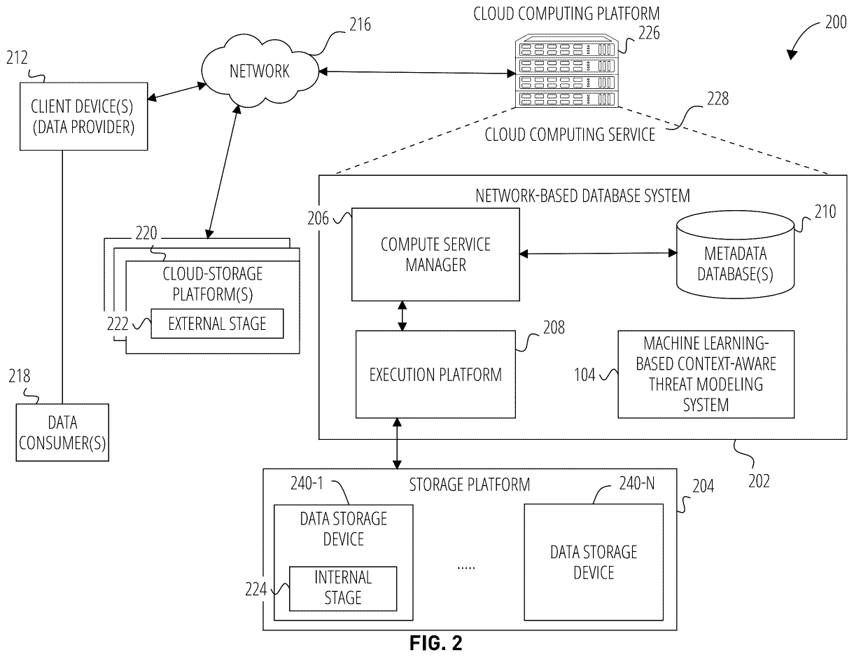

FIG. 2 illustrates an example computing environment 200 comprising a database system in the example form of a network-based database system 202 that includes a machine learning-based context-aware threat modeling system 104, according to some example embodiments of the present disclosure. To avoid obscuring the inventive subject matter with unnecessary detail, various functional components that are not germane to conveying an understanding of the inventive subject matter have been omitted from FIG. 2. However, a skilled artisan will readily recognize that various additional functional components may be included as part of the computing environment 200 to facilitate additional functionality that is not specifically described herein. In other embodiments, the computing environment may comprise another type of network-based database system or a cloud data platform. For example, in some example embodiments, the computing environment 200 may include a cloud computing platform 226 with the network-based database system 202, and a storage platform 204 (also referred to as a cloud storage platform). The cloud computing platform 226 provides computing resources and storage resources that may be acquired (purchased) or leased and configured to execute applications and store data.

The cloud computing platform 226 may host a cloud computing service 228 that facilitates storage of data on the cloud computing platform 226 (e.g., data management and access) and analysis functions (e.g., SQL queries, analysis), as well as other processing capabilities (e.g., configuring replication group objects as described herein). The cloud computing platform 226 may include a three-tier architecture: data storage (e.g., storage platforms 204), an execution platform (XP) 208 (e.g., providing query processing), and a compute service manager 206 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 226 could also use a cloud-storage platform as what is referred to herein as an internal storage location concerning the data platform.

From the perspective of the network-based database system 202 of the cloud computing platform 226, one or more files that are stored at one or more storage locations are referred to herein as being organized into one or more of what is referred to herein as either “internal stages” or “external stages.” Internal stages (e.g., internal stage 224) are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 202 of the cloud computing platform 226 is in communication with the storage platforms 204 and cloud-storage platforms 220 (e.g., AWS Microsoft Azure Blob Storage®, or Google Cloud Storage). The network-based database system 202 is a network-based system used for reporting and analysis of integrated data from one or more disparate sources including one or more storage locations within the storage platform 204. The storage platform 204 comprises a plurality of computing machines and provides on-demand computer system resources such as data storage and computing power to the network-based database system 202.

The network-based database system 202 comprises a compute service manager 206, an execution platform 208, and one or more metadata databases 210. The network-based database system 202 hosts and provides data reporting and analysis services to multiple client accounts.

The compute service manager 206 coordinates and manages operations of the network-based database system 202. The compute service manager 206 also performs query optimization and compilation as well as managing clusters of computing services that provide compute resources (also referred to as “virtual warehouses”). The compute service manager 206 can support any number of client accounts such as end-users providing data storage and retrieval requests, system administrators managing the systems and methods described herein, and other components/devices that interact with compute service manager 206.

The compute service manager 206 is also in communication with a client device 212. The client device 212 corresponds to a user of one of the multiple client accounts supported by the network-based database system 202. A user may utilize the client device 212 to submit data storage, retrieval, and analysis requests to the compute service manager 206. Client device 212 (also referred to as remote computing device or user client device 212) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 226 (e.g., cloud computing service 228) by way of a network 216, such as the Internet or a private network. A data consumer 218 can use another computing device to access the data of the data provider (e.g., data obtained via the client device 212).

In the description below, actions are ascribed to users, particularly consumers and providers. Such actions shall be understood to be performed concerning client device (or devices) 212 operated by such users. For example, a notification to a user may be understood to be a notification transmitted to the client device 212, input or instruction from a user may be understood to be received by way of the client device 212, and interaction with an interface by a user shall be understood to be interaction with the interface on the client device 212. In addition, database operations (joining, aggregating, analysis, etc.) ascribed to a user (consumer or provider) shall be understood to include performing such actions by the cloud computing service 228 in response to an instruction from that user.

The compute service manager 206 is also coupled to one or more metadata databases 210 that store metadata about various functions and aspects associated with the network-based database system 202 and its users. For example, a metadata database 210 may include a summary of data stored in remote data storage systems as well as data available from a local cache. Additionally, a metadata database 210 may include information regarding how data is organized in remote data storage systems (e.g., the cloud storage platform 204) and the local caches. Information stored by a metadata database 210 allows systems and services to determine whether a piece of data needs to be accessed without loading or accessing the actual data from a storage device. In some example embodiments, metadata database 210 is configured to store account object metadata (e.g., account objects used in connection with a replication group object).

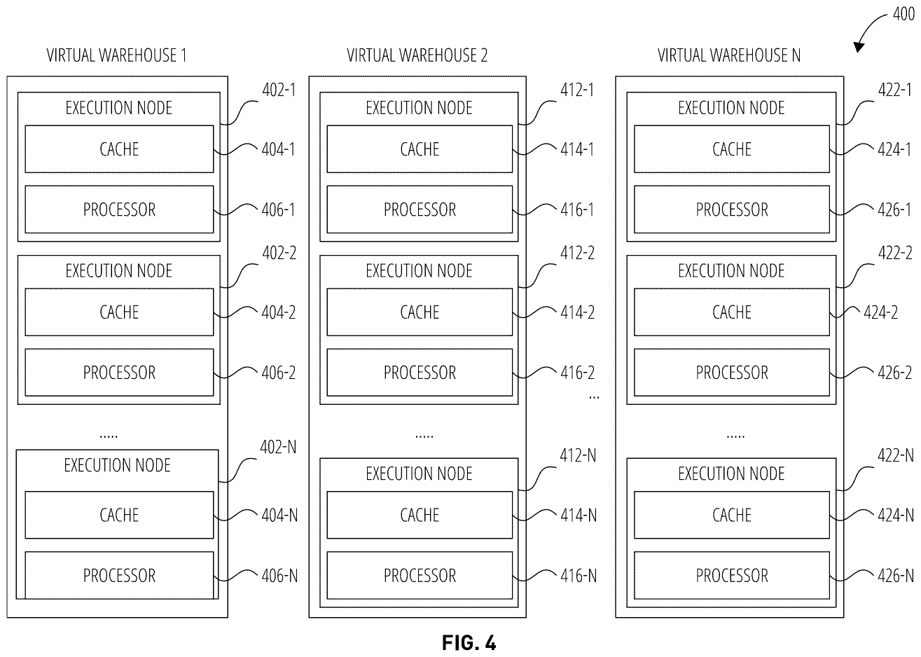

The compute service manager 206 is further coupled to the execution platform 208, which provides multiple computing resources that execute various data storage and data retrieval tasks. As illustrated in FIG. 4, the execution platform 208 comprises a plurality of compute nodes. The execution platform 208 is coupled to storage platform 204 and cloud-storage platforms 220. The storage platform 204 comprises multiple data storage devices 240-1 to 240-N. In some example embodiments, the data storage devices 240-1 to 240-N are cloud-based storage devices located in one or more geographic locations. For example, the data storage devices 240-1 to 240-N may be part of a public cloud infrastructure or a private cloud infrastructure. The data storage devices 240-1 to 240-N may be hard disk drives (HDDs), solid-state drives (SSDs), storage clusters, Amazon S3™ storage systems, or any other data-storage technology. Additionally, the cloud storage platform 204 may include distributed file systems (such as Hadoop Distributed File Systems (HDFS)), object storage systems, and the like. In some example embodiments, at least one internal stage 224 may reside on one or more of the data storage devices 240-1-240-N, and at least one external stage 222 may reside on one or more of the cloud-storage platforms 220.

In some example embodiments, communication links between elements of the computing environment 100 are implemented via one or more data communication networks. These data communication networks may utilize any communication protocol and any type of communication medium. In some example embodiments, the data communication networks are a combination of two or more data communication networks (or sub-networks) coupled to one another. In alternative embodiments, these communication links are implemented using any type of communication medium and any communication protocol.

The compute service manager 206, metadata database(s) 210, execution platform 208, and storage platform 204, are shown in FIG. 2 as individual discrete components. However, each of the compute service manager 206, metadata database(s) 210, execution platform 208, and storage platform 204 may be implemented as a distributed system (e.g., distributed across multiple systems/platforms at multiple geographic locations). Additionally, each of the compute service manager 206, metadata database(s) 210, execution platform 208, and storage platform 204 can be scaled up or down (independently of one another) depending on changes to the requests received and the changing needs of the network-based database system 202. Thus, in the described embodiments, the network-based database system 202 is dynamic and supports regular changes to meet the current data processing needs.

During a typical operation, the network-based database system 202 processes multiple jobs determined by the compute service manager 206. These jobs are scheduled and managed by the compute service manager 206 to determine when and how to execute the job. For example, the compute service manager 206 may divide the job into multiple discrete tasks and may determine what data is needed to execute each of the multiple discrete tasks. The compute service manager 206 may assign each of the multiple discrete tasks to one or more nodes of the execution platform 208 to process the task. The compute service manager 206 may determine what data is needed to process a task and further determine which nodes within the execution platform 208 are best suited to process the task. Some nodes may have already cached the data needed to process the task and, therefore, be a good candidate for processing the task. Metadata stored in a metadata database 210 assists the compute service manager 206 in determining which nodes in the execution platform 208 have already cached at least a portion of the data needed to process the task. One or more nodes in the execution platform 208 process the task using data cached by the nodes and, if necessary, data retrieved from the storage platform 204. It is desirable to retrieve as much data as possible from caches within the execution platform 208 because the retrieval speed is typically much faster than retrieving data from the storage platform 204.

As shown in FIG. 2, the cloud computing platform 226 of the computing environment 200 separates the execution platform 208 from the storage platform 204. In this arrangement, the processing resources and cache resources in the execution platform 208 operate independently of the data storage devices 240-1 to 240-N in the storage platform 204. Thus, the computing resources and cache resources are not restricted to specific data storage devices 240-1 to 240-N. Instead, all computing resources and all cache resources may retrieve data from, and store data to, any of the data storage resources in the storage platform 204.

As also shown, the network-based database system 202 comprises machine learning-based context-aware threat modeling system 104. According to various example embodiments, the machine learning-based context-aware threat modeling system 104 enables or facilitates threat modeling for at least a portion of one or more target systems or sub-systems supported or implemented using the network-based database system 202.

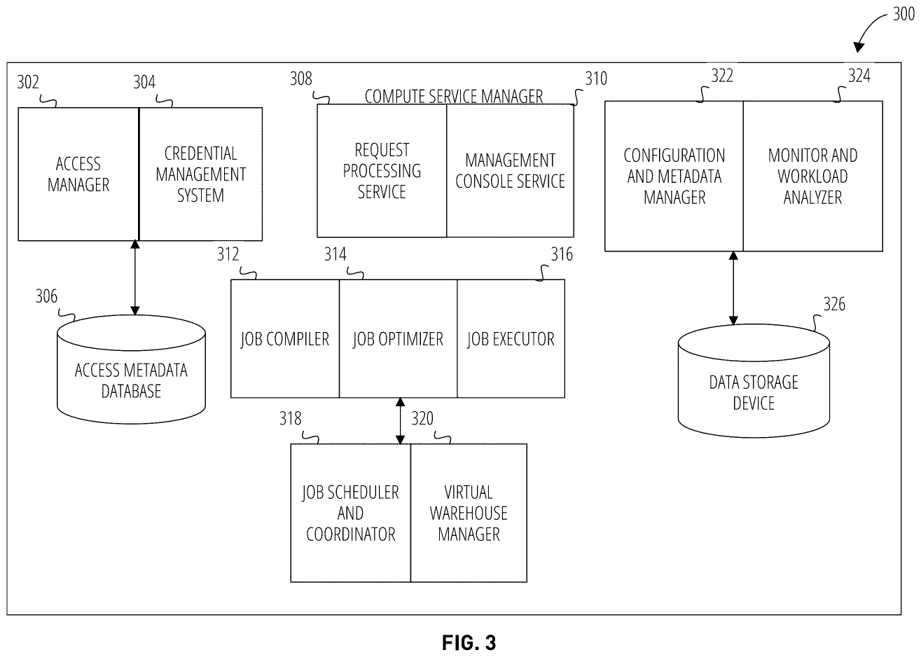

FIG. 3 is a block diagram 300 illustrating components of the compute service manager 206, according to some example embodiments of the present disclosure. As shown in FIG. 3, the compute service manager 206 includes an access manager 302 and a credential management system 304 coupled to access access metadata database 306, which is an example of the metadata database(s) 210.

Access manager 302 handles authentication and authorization tasks for the systems described herein. The credential management system 304 facilitates use of remote stored credentials to access external resources such as data resources in a remote storage device. As used herein, the remote storage devices may also be referred to as “persistent storage devices” or “shared storage devices.” For example, the credential management system 304 may create and maintain remote credential store definitions and credential objects (e.g., in the access metadata database 306). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 304 and access manager 302 use information stored in the access metadata database 306 (e.g., a credential object and a credential store definition) to retrieve security credentials used to access the external resource from a remote credential store.

A request processing service 308 manages received data storage requests and data retrieval requests (e.g., jobs to be performed on database data). For example, the request processing service execution platform 208 may determine the data to process a received query (e.g., a data storage request or data retrieval request). The data can be stored in a cache within the execution platform 208 or in a data storage device in storage platform 204.

A management console service 310 supports access to various systems and processes by administrators and other system managers. Additionally, the management console service 310 may receive a request to execute a job and monitor the workload on the system.

The compute service manager 206 also includes a job compiler 312, a job optimizer 314, and a job executor 316. The job compiler 312 parses a job into multiple discrete tasks and generates the execution code for each of the multiple discrete tasks. The job optimizer 314 determines the best method to execute the multiple discrete tasks based on the data that needs to be processed. The job optimizer 314 also handles various data pruning operations and other data optimization techniques to improve the speed and efficiency of executing the job. The job executor 316 executes the execution code for jobs received from a queue or determined by the compute service manager 206.

A job scheduler and coordinator 318 sends received jobs to the appropriate services or systems for compilation, optimization, and dispatch to the execution platform 208. For example, jobs can be prioritized and then processed in that prioritized order. In an embodiment, the job scheduler and coordinator 318 determines a priority for internal jobs that are scheduled by the compute service manager 206 with other “outside” jobs such as user queries that can be scheduled by other systems in the database but may utilize the same processing resources in the execution platform 208. In some example embodiments, the job scheduler and coordinator 318 identifies or assigns particular nodes in the execution platform 208 to process particular tasks. A virtual warehouse manager 320 manages the operation of multiple virtual warehouses implemented in the execution platform 208. For example, the virtual warehouse manager 320 may generate query plans for executing received queries.

Additionally, the compute service manager 206 includes a configuration and metadata manager 322, which manages the information related to the data stored in the remote data storage devices and in the local buffers (e.g., the buffers in execution platform 208). The configuration and metadata manager 322 uses metadata to determine which data files need to be accessed to retrieve data for processing a particular task or job. A monitor and workload analyzer 324 oversees processes performed by the compute service manager 206 and manages the distribution of tasks (e.g., workload) across the virtual warehouses and execution nodes in the execution platform 208. The monitor and workload analyzer 324 also redistributes tasks, as needed, based on changing workloads throughout the cloud computing platform 226 and may further redistribute tasks based on a user (e.g., “external”) query workload that may also be processed by the execution platform 208. The configuration and metadata manager 322 and the monitor and workload analyzer 324 are coupled to a data storage device 326. Data storage device 326 in FIG. 3 represents any data storage device within the storage platform 204. For example, data storage device 326 may represent buffers in execution platform 208, storage devices in cloud storage platform 204, or any other storage device.

As described in embodiments herein, the compute service manager 206 validates all communication from an execution platform (e.g., the execution platform 208) to validate that the content and context of that communication are consistent with the task(s) known to be assigned to the execution platform. For example, an instance of the execution platform executing a query A should not be allowed to request access to data-source D (e.g., data storage device 326) that is not relevant to query A. Similarly, a given execution node (e.g., execution node 402-1) may need to communicate with another execution node (e.g., execution node 402-2), and should be disallowed from communicating with a third execution node (e.g., execution node 412-1) and any such illicit communication can be recorded (e.g., in a log or other location). Also, the information stored on a given execution node is restricted to data relevant to the current query and any other data is unusable, rendered so by destruction or encryption where the key is unavailable.

FIG. 4 is a block diagram 400 illustrating components of the execution platform 208, according to some example embodiments of the present disclosure. As shown in FIG. 4, the execution platform 208 includes multiple virtual warehouses, including virtual warehouse 1, virtual warehouse 2, and virtual warehouse N. Each virtual warehouse includes multiple execution nodes that each include a data cache and a processor. The virtual warehouses can execute multiple tasks in parallel by using the multiple execution nodes. As discussed herein, the execution platform 208 can add new virtual warehouses and drop existing virtual warehouses in real-time based on the current processing needs of the systems and users. This flexibility allows the execution platform 208 to quickly deploy large amounts of computing resources when needed without being forced to continue paying for those computing resources when they are no longer needed. All virtual warehouses can access data from any data storage device (e.g., any storage device in storage platform 204).

Although each virtual warehouse shown in FIG. 4 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer useful.

Each virtual warehouse is capable of accessing any of the data storage devices 240-1 to 240-N shown in FIG. 2. Thus, the virtual warehouses are not necessarily assigned to a specific data storage device 240-1 to 240-N and, instead, can access data from any of the data storage devices 240-1 to 240-N within the storage platform 204. Similarly, each of the execution nodes shown in FIG. 4 can access data from any of the data storage devices 240-1 to 240-N. In some example embodiments, a particular virtual warehouse or a particular execution node can be temporarily assigned to a specific data storage device, but the virtual warehouse or execution node may later access data from any other data storage device.

In the example of FIG. 4, virtual warehouse 1 includes three execution nodes 402-1, 402-2, and 402-N. Execution node 402-1 includes a cache 404-1 and a processor 406-1. Execution node 402-2 includes a cache 404-2 and a processor 406-2. Execution node 402-N includes a cache 404-N and a processor 406-N. Each execution node 402-1, 402-2, and 402-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 412-1, 412-2, and 412-N. Execution node 412-1 includes a cache 414-1 and a processor 416-1. Execution node 412-2 includes a cache 414-2 and a processor 416-2. Execution node 412-N includes a cache 414-N and a processor 416-N. Additionally, virtual warehouse N includes three execution nodes 422-1, 422-2, and 422-N. Execution node 422-1 includes a cache 424-1 and a processor 426-1. Execution node 422-2 includes a cache 424-2 and a processor 426-2. Execution node 422-N includes a cache 424-N and a processor 426-N.

In some example embodiments, the execution nodes shown in FIG. 4 are stateless with respect to the data being cached by the execution nodes. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 4 each includes one data cache and one processor, alternate embodiments may include execution nodes containing any number of processors and any number of caches. Additionally, the caches may vary in size among the different execution nodes. The caches shown in FIG. 4 store, in the local execution node, data that was retrieved from one or more data storage devices in storage platform 204. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some example embodiments, the caches are implemented using high-speed memory devices that provide fast access to the cached data. Each cache can store data from any of the storage devices in the storage platform 204.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some example embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 208, the virtual warehouses can be implemented using multiple computing systems at multiple geographic locations. For example, virtual warehouse 1 can be implemented by a computing system at a first geographic location, while virtual warehouses 2 and N are implemented by another computing system at a second geographic location. In some example embodiments, these different computing systems are cloud-based computing systems maintained by one or more different entities.

Additionally, each virtual warehouse is shown in FIG. 4 as having multiple execution nodes. The multiple execution nodes associated with each virtual warehouse can be implemented using multiple computing systems at multiple geographic locations. For example, an instance of virtual warehouse 1 implements execution nodes 402-1 and 402-2 on one computing platform at a geographic location and implements execution node 402-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 208 is also fault tolerant. For example, if one virtual warehouse fails, that virtual warehouse is quickly replaced with a different virtual warehouse at a different geographic location. A particular execution platform 208 may include any number of virtual warehouses. Additionally, the number of virtual warehouses in a particular execution platform is dynamic, such that new virtual warehouses are created when additional processing and/or caching resources are needed. Similarly, existing virtual warehouses can be deleted when the resources associated with the virtual warehouse are no longer useful.

In some example embodiments, the virtual warehouses may operate on the same data in storage platform 204, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance.

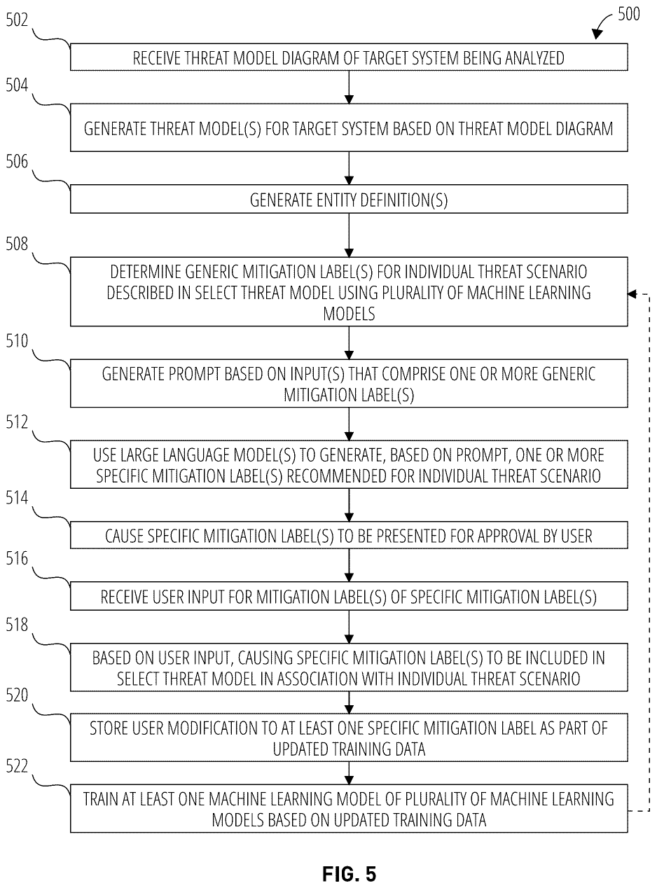

FIG. 5 is a flowchart of an example method 500 for threat modeling a target system using one or more machine learning models and context information, according to some example embodiments of the present disclosure. Method 500 may be embodied in computer-readable instructions for execution by one or more hardware components (e.g., one or more processors) such that the operations of method 500 can be performed by components of the machine learning-based context-aware threat modeling system 104 or the network-based database system 202, such as a network node (e.g., the machine learning-based context-aware threat modeling system 104 executing on a network node of the compute service manager 206) or a computing device (e.g., client device 212), one or both of which may be implemented as machine 1200 of FIG. 12 performing the disclosed functions. Accordingly, method 500 is described below, by way of example with reference thereto. However, it shall be appreciated that method 500 may be deployed on various other hardware configurations and is not intended to be limited to deployment within the network-based database system 202.

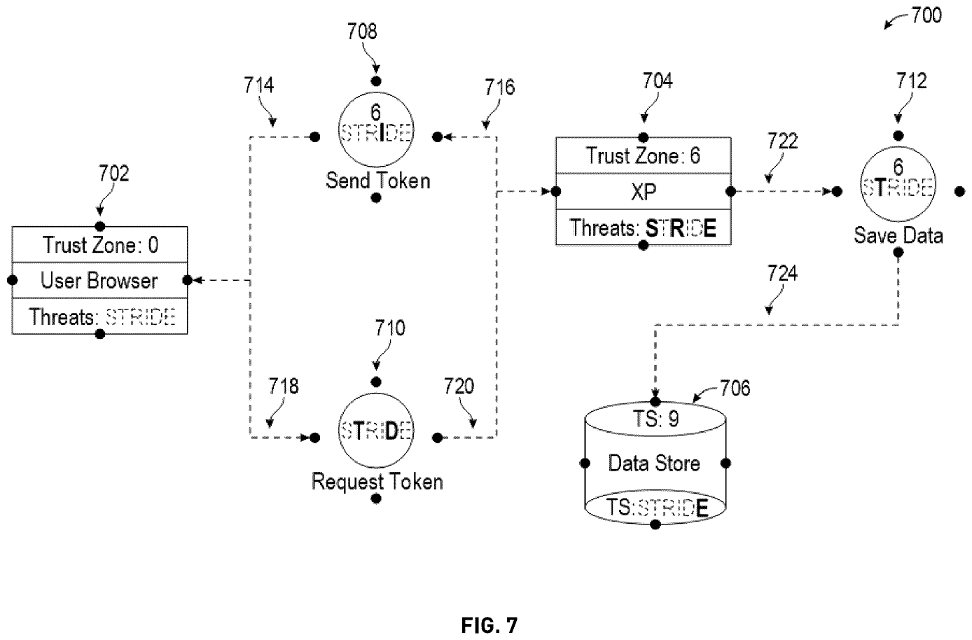

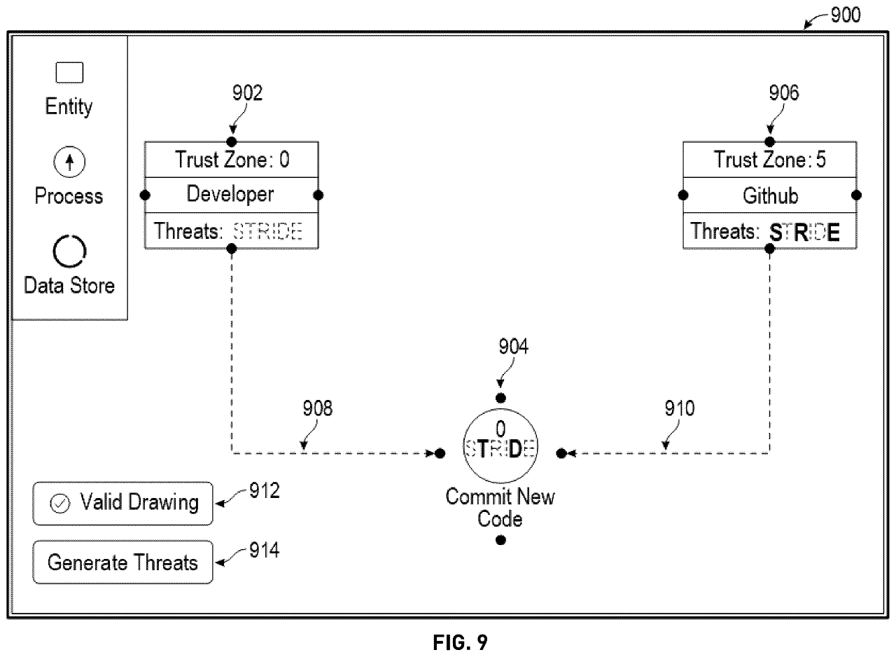

At operation 502, a processor (e.g., implementing the machine learning-based context-aware threat modeling system 104) receives a threat model diagram, such as a threat model graph of a target system being analyzed. The threat model diagram can cover those portions of a larger system that are being developed or otherwise modified (e.g., changes to a process, an entity, or dataflow between entities) by an engineer (e.g., developer) and, therefore, are being analyzed (e.g., by the machine learning-based context-aware threat modeling system 104) for threats/risks. For some example embodiments, the threat model diagram comprises a threat model graph, which can comprise a plurality of nodes and a set of edges, where each node of the plurality of nodes represents a different entity (e.g., physical or virtual computing device or another component) of the target system, and where each edge of the set of edges is associated with a different process-related data flow between two nodes of the threat model graph. The threat model diagram can be drafted (e.g., drawn) by a user (e.g., engineer) using a software tool with a graphical user interface (e.g., accessed via a website portal). Example threat model graphs are illustrated and described with respect to FIG. 7 and FIG. 9.

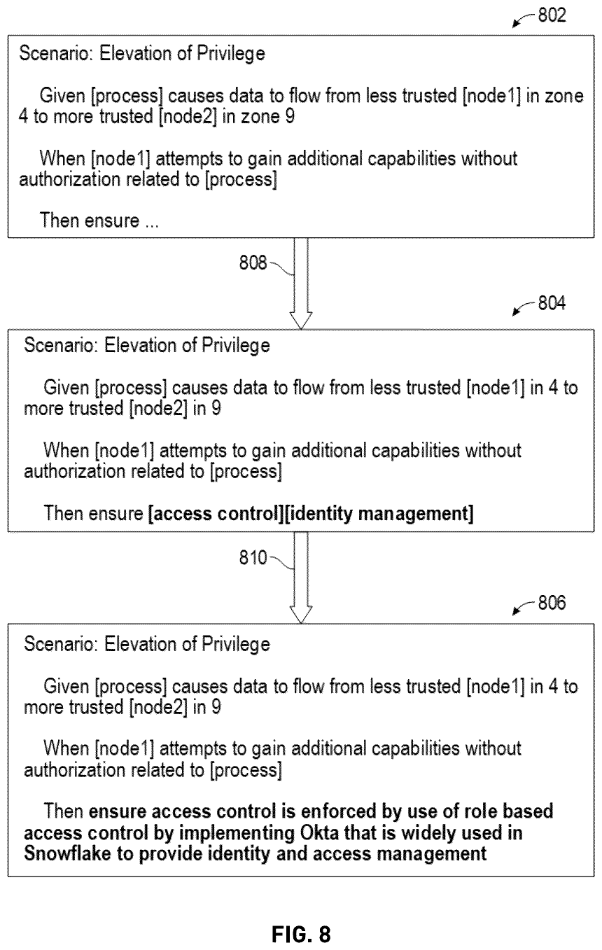

During operation 504, the processor generates a set of threat models for the target system based on the threat model diagram. According to various example embodiments, a select threat model (e.g., each threat model) of the set of threat models comprises a data object that uses a structured natural language, such as Gherkin, to describe a set of applicable threat scenarios for the target system and to describe a set of mitigation strategies for the set of applicable threat scenarios. A threat model generated during operation 504 can represent an initial threat model (e.g., shell thread model or a template threat model) that describes one or more threat scenarios with threat scenario information (e.g., identifying a threat category, such as one of the STRIDE categories, and providing a description of the threat scenario) but without details for corresponding mitigation strategies included. An example threat scenario of an initial threat model generated by operation 504 is illustrated and described with respect to a threat scenario 802 of an initial threat model of FIG. 8. For operation 504, one or more threat models are generated for each individual process-related data flow (described or represented in the threat model diagram) between two entities. For some example embodiments, the processor uses a threat scenario analysis system to analyze one or more (e.g., each) individual process-related data flow in the threat model diagram and to generate the one or more threat models (e.g., expressed in structured natural language) for the individual process-related data flow based on the analysis. For instance, the threat scenario analysis system can comprise a STRIDE analysis system, which can use RTMP to shorten the STRIDE analysis process performed on the threat model diagram.

Depending on example embodiment, where there are multiple threat models, one or more of operations 506 through 522 can be performed for each threat model generated. Additionally, where a given threat model comprises multiple threat scenarios (e.g., in association with one or more process-related data flows of the target system), one or more of operations 508 through 522 can be performed (e.g., individually) for each of those multiple threat scenarios. For instance, one or more of operations 506 through 522 can be performed on a first threat model for the target system, with one or more of operations 508 through 522 being performed on each threat scenario described in the first threat model, and (e.g., in parallel or thereafter) one or more of operations 506 through 522 can be performed on a second threat model for the target system, with one or more of operations 508 through 522 being performed on each threat scenario described in the second threat model.

At operation 504, the processor generates a set of entity definitions (e.g., node definitions) for a set of entities (e.g., nodes) of the target system. The set of entity definitions can be one or all of the entities described (e.g., represented) in the threat model diagram. The definition for a given entity can comprise a natural language definition of the entity, which can include a formal or alternate name (e.g., one used in other existing threat models, engineer documents, or security guidelines) for the entity or a description of the entity. For some example embodiments, the generation of at least some portion of the set of entity definitions comprises generating an entity definition for a select entity (of the set of entities) by matching the select entity to an existing entity definition. The existing definition can be part of a plurality of existing entity definitions (that can be known, predefined, or discovered/learned) with respect to an organization associated with the target system. For instance, an XP entity can be matched to an existing, organization-specific definition for execution platform, and a datastore can be matched to an existing, organization-specific definition of database. In this way, non-unified entity names (used by members of an organization) within a threat model diagram can be understood by the machine learning-based context-aware threat modeling system. The plurality of entity definitions can be defined (e.g., entered manually) by an organization member (e.g., organization developer) or one discovered or learned using machine learning, extraction, or analytical techniques (e.g., machine learning technique used to learn entity definitions from existing threat models or organization documents, such as engineering documents or security guidelines). For some example embodiments, the generation of at least some portion of the set of entity definitions comprises requesting an entity (e.g., node) definition for a select entity (e.g., node) from a user (e.g., the engineer). Such a request can occur, for example, after an automatic match of the select entity to an existing entity definition fails. For some example embodiments, the generation of at least some portion of the set of entity definitions comprises using a machine learning model (e.g., trained on existing threat models, engineering documents, or security guidelines) to generate an entity definition.

Depending on example embodiment, the process for determining a plurality of existing entity definitions can comprise: extracting an initial set of entities (e.g., list of nodes) from existing threat models (e.g., threat model Gherkins); filtering the initial set of entities, such as using machine learning model-based clustering and manual review of the clustering output; and providing access to the filtered set of entities (as the plurality of existing entity definitions), such as through an application program interface (API). When an engineer is developing a threat model diagram, the engineer can search through and select entity names from the plurality of entities, or the user interface (e.g., graphical user interface) used by the engineer can auto-suggest relevant entity names as the engineer develops the threat model diagram.

For illustrative purposes, operations 508 through 522 are described with respect to an individual threat scenario described in a select threat model of the set of threat models. At operation 508, the processor determines a set of generic mitigation labels for the individual threat scenario using a plurality of machine learning models. According to various example embodiments, each generic mitigation label corresponds to a generic mitigation strategy (e.g., mitigation solution or mechanism, such as access control or encryption) for mitigating a threat scenario. A generic mitigation strategy can be considered a mitigation strategy that is selected for a threat scenario without considering context information (e.g., relevant context information) relating to an organization associated with the target system. For various example embodiments, operation 508 comprises inputting the individual threat scenario (from the select threat model) into each individual machine learning model of the plurality of machine learning models. Operation 508 can comprise inputting a list of entities (e.g., nodes) of the threat model diagram (e.g., threat model graph) into each individual machine learning model of the plurality of machine learning models. Operation 508 can comprise inputting data describing at least a portion of a threat scenario analysis methodology (used to analyze the threat model diagram to generate the select threat model) into each individual machine learning model of the plurality of machine learning models. For example, the threat scenario analysis methodology can comprise the STRIDE analysis methodology. Operation 508 can comprise inputting data describing a prototyping methodology into each individual machine learning model of the plurality of machine learning models, where the prototyping methodology is used to analyze the threat model graph to generate the select threat model. For instance, the prototyping methodology can comprise RTMP (e.g., that comprises the set of rules that cause STRIDE analysis to shorten its analysis of the select threat model for a set of threat scenario categories). An individual machine learning model of the plurality of machine learning models can be configured (e.g., trained) to output a determination of whether to include an individual generic mitigation label associated with (e.g., corresponding to) the individual machine learning model in a respective threat model received as input by the individual machine learning model. Each individual machine learning model of the plurality of machine learning models can be associated with (e.g., trained to detect for) a different generic mitigation label. An example threat scenario of a threat model that includes one or more generic mitigation labels is illustrated and described with respect to a threat scenario 804 of FIG. 8.

During operation 510, the processor generates a prompt (e.g., for input into one or more LLMs) based on a set of inputs, where the set of inputs comprises the set of generic mitigation labels determined by operation 508. Thereafter, at operation 512, the processor uses a set of LLMs to generate a set of specific mitigation labels recommended for the individual threat scenario based on the prompt. Depending on the example embodiment, the prompt can comprise some pre-instructions, annotations, embeddings (e.g., with most common definitions and requirements for an organization), and the like. For example, the prompt instructions that direct an LLM to generate a set of specific mitigation labels, based on the set of generic mitigation labels, in view of one or more other inputs included in the set of inputs (e.g., that provide context information for an organization), such as a set of engineering documents, a set of security guidelines, a set of organization requirements, the set of entity definitions (for the threat model diagram) generated by operation 506, and the like. An LLM used can use RAG to obtain as input (as context information) the set of engineering documents, the set of security guidelines, the set of organization requirements, or the like.

The prompt instructions can include additional instructions with respect to sorting, prioritizing, and formatting the set of specific mitigation labels output by an LLM. According to some example embodiments, each specific mitigation label corresponds to a specific, context-aware mitigation strategy, such as encryption methodology, access control methodology, or multi-factor authentication methodology specific to an organization (e.g., the engineer's organization) that owns, controls, or uses the target system. In this way, each specific mitigation label can correspond to a mitigation strategy specific to the organization associated with the target system. For instance, a specific mitigation strategy can be considered one that takes into account context information associated with the organization (e.g., company), such as specific engineering documents, security guidelines, or tools of the organization. Eventually, one or more of the specific mitigation labels of the set of specific mitigation labels can be included by (or inserted into) the select threat model in association with the individual threat scenario.

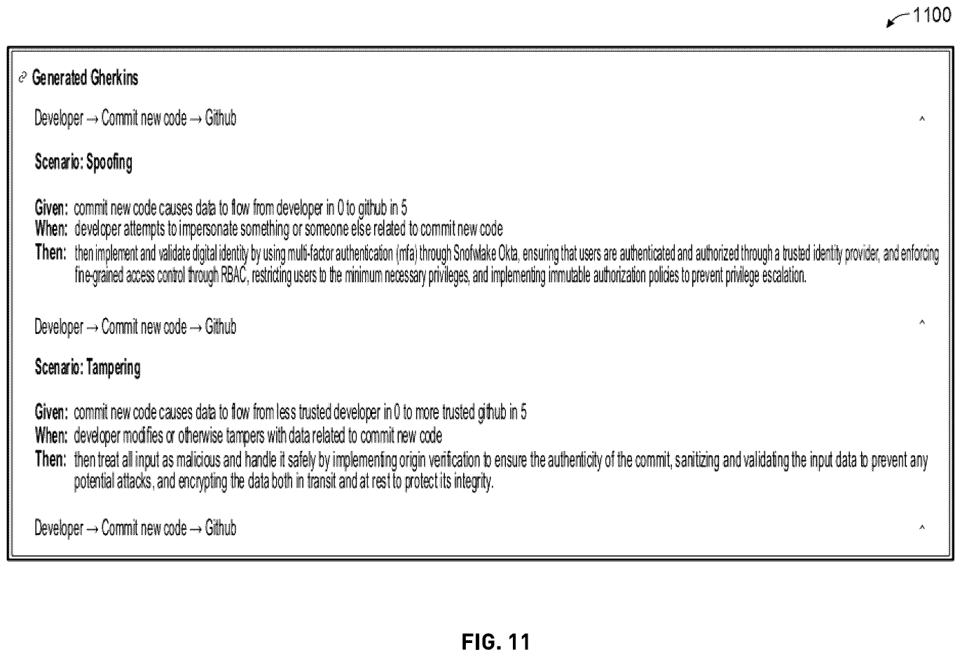

Prior to any specific mitigation label being included by (or inserted into) the select threat model, a user (e.g., engineer) can review one or more of the set of specific mitigation labels determined by operation 512. In particular, at operation 514, the processor causes at least some portion of the set of specific mitigation labels to be presented (e.g., displayed) for approval by the user. For instance, the processor can cause the individual threat scenario to be displayed in a graphical user interface with one or more of the set of specific mitigation labels. An example of this is illustrated and described with respect to FIG. 11. At operation 516, the processor receives user input with the one or more specific mitigation labels of the set of specific mitigation labels and, at operation 518, based on the user input, the processor causes the one or more specific mitigation labels to be included by (or inserted into) the individual threat model in association with the individual threat scenario. For example, at operation 516, the processor can receive a set of acceptances for one or more specific mitigation labels of the set of specific mitigation labels and, at operation 518, the processor can cause the one or more specific mitigation labels (based on the set of acceptances) to be included in (or inserted into) the individual threat model in association with the individual threat scenario. In particular, the one or more specific mitigation labels can be included (or inserted into) a mitigation strategy portion of the select threat model that corresponds to (e.g., addresses) the individual threat scenario. For some example embodiments, at least one acceptance of the set of acceptances comprises a modification to at least one specific mitigation label of the one or more specific mitigation labels to be included in the individual threat model in association with the individual threat scenario. The at least one specific mitigation label as modified can then be included by (or inserted into) the mitigation strategy portion of the select threat model that corresponds to (e.g., addresses) the individual threat scenario.

To improve the performance of the thread modeling system, one or more modification received from a user (with respect to one or more specific mitigation labels) can be stored (e.g., logged) for use as training data (e.g., updated training data) to train one or more machine learning models of the plurality of machine learning models. For instance, where a user accepts a given specific mitigation label with a modification, the modification be stored as training data (e.g., updated training data) to be used to train a machine learning model (of the plurality of machine learning models) that corresponds to the given specific mitigation label (e.g., the machine learning model trained to detect for whether the given specific mitigation label should be included for the individual threat scenario). At operation 520, the processor stores a modification (e.g., received during operation 518) as part of updated training data and, at operation 522, the processor trains at least one machine learning model of the plurality of machine learning models based on the updated training data. Eventually, method 500 can return to operation 508 to process another threat scenario of the select threat model.

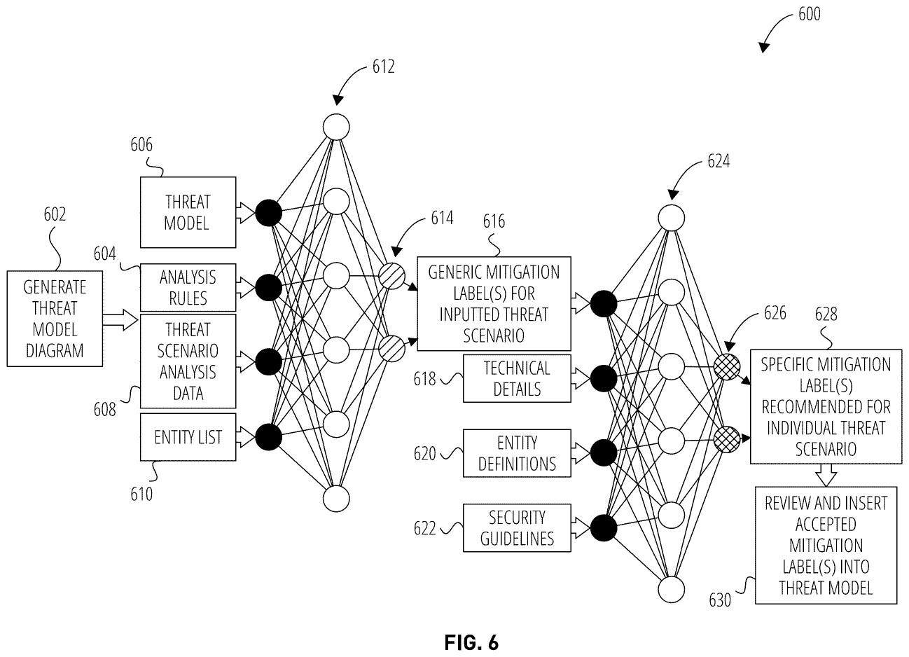

FIG. 6 is a diagram illustrating an example data flow 600 for a machine learning-based context-aware threat modeling system, according to some example embodiments of the present disclosure. As shown, a threat model diagram (e.g., threat model graph) is generated (602) for a target system by a user (e.g., engineer, such as developer), which results in generation of at least one threat model 606 that describes a set of threat scenarios for the target system. Each individual threat scenario described in the threat model 606 is inputted (e.g., individually) into each machine learning model of a plurality of machine learning models 612 to generate a plurality of outputs 614 (e.g., comprising mitigation labels with confidence scores), from which a set of generic mitigation labels 616 are determined for an inputted threat scenario. Along with an individual threat scenario, one or more of analysis rules 604 (e.g., for RTMP), threat scenario analysis data 608 (e.g., STRIDE analysis methodology data), or an entity list 610 for entities in the threat model diagram are inputted to each machine learning model of the plurality of machine learning models 612. To determine a set of specific mitigation label 628 for an individual threat scenario, a prompt is generated based on the set of generic mitigation labels 616 determined for the individual threat scenario by the plurality of machine learning models 612, and the prompt is processed by a set of LLMs 624, where the set of specific mitigation label 628 is provided in LLM output 626 from the set of LLMs 624. In addition to the prompt, the set of LLMs 624 can receive context information (e.g., for an organization) associated with the target system, such as one or more of technical details 618 (e.g., engineering documents), entity definitions 620 (e.g., node definitions) determined for entities present in the threat model diagram (e.g., threat model graph), and security guidelines 622. Subsequently, the set of specific mitigation label 628 can be reviewed (630) by a user (e.g., engineer, such as a developer or a security engineer) prior to the set of specific mitigation label 628 being included or inserted into an individual threat model in association with the individual threat scenario (e.g., inserted into the mitigation strategy portion of the individual threat model that corresponds to the individual threat scenario). Additionally, or alternatively, a project management ticket (e.g., JIRA ticket) can be generated with the set of specific mitigation label 628, thereby assigning the engineer (e.g., developer or security engineer) with a task to review or enter the set of specific mitigation label 628 or the individual threat model after mitigation label insertion.

FIG. 7 illustrates an example threat model graph 700 that can be received or generated by a machine learning-based context-aware threat modeling system, according to some example embodiments of the present disclosure. As shown, the threat model graph 700 comprises a node 702 corresponding to a “user browser” entity in a trust zone 0, a node 704 corresponding to a “XP” (execution platform) (e.g., execution platform 208 of FIG. 2) entity in a trust zone of 6, a node 706 corresponding to a “data store” entity in trust zone 9, a process 708 with edges between node 704 and node 702 for a data flow from the “XP” entity to the “user browser” entity, a process 710 with edges between node 702 and node 704 for a data flow from the “user browser” entity to the “XP” entity, and a process 712 with edges between node 704 and node 706 for a data flow from the “XP” entity to the “data store” entity. The process 708 corresponds to a “send token” process, the process 710 corresponds to a “request token” process, and the process 712 correspond to a “save data” process.

FIG. 8 illustrates an example of specific mitigation labels being determined according to some example embodiments of the present disclosure. In particular, a threat scenario 802 represents a threat scenario within an initial (e.g., template) threat model generated based on a threat model diagram (e.g., threat model graph). After the threat scenario 802 is processed by machine learning models (e.g., 612), a set of generic mitigation labels (e.g., 616) is determined for the threat scenario 802, which is represented in threat scenario 804. As shown, the generic mitigation labels include “access control” (which corresponds to a generic mitigation strategy of access control) and “identity management” (which corresponds to a generic mitigation strategy of identity management). After the set of generic mitigation labels is processed by a set of LLMs (e.g., 624), a set of specific mitigation labels (e.g., 628) is determined for the threat scenario 802, which is represented in threat scenario 806. As shown, the set of specific mitigation labels comprises “ensure access control is enforced by user of role-based access control by implementing Okta that is widely used in Snowflake to provide identity and access management.” These specific mitigation labels illustrate not only the details of specific mitigation strategies recommended for the threat scenario 802, but also why the specific mitigation strategies should be used.

FIG. 9 illustrates an example graphical user interface 900 presented by a machine learning-based context-aware threat modeling system for generating a threat model diagram, according to some example embodiments of the present disclosure. The graphical user interface 900 can be presented by the graphical user interface 120 to enable a user (e.g., engineer, such as a developer or security engineer) to draft a threat model diagram (e.g., threat model graph) or submit a threat model diagram. As shown, the graphical user interface 900 displays a threat model graph 902 drafted by a user, which includes a node 904 corresponding to a “developer” entity (e.g., developer's client computing device), a node 906 corresponding to a “github” entity that represents a source code repository, and a process 908 with edges between node 904 and node 906 for a data flow from the “developer” entity to the “github” entity, where the process 908 corresponds to a “commit new code” process. Upon a user selecting (e.g., clicking on) the graphical button 912 (or a similar graphical user interface element) through the graphical user interface 900, a machine learning-based context-aware threat modeling system to generate a set of initial (e.g., template) threat models for the data flow associated with the process 908 of the threat model graph 902. As described herein, a threat scenario analysis process or system to generate the set of initial threat models, where each threat model comprises one or more threat scenarios that each describe information for an individual threat scenario and an empty (e.g., shell) mitigation strategy section corresponding to the individual threat scenario. After the set of initial threat models are generated for the data flow, each of the node 904, the node 906, and the process 908 can have a graphical indicator (threat scenario indicators 918, 916, and 914 respectively) to indicate which threat scenario categories are described by the set of initial threat models for the data flow. As shown, the set of initial threat models for the data flow describes threat scenarios for STRIDE threat categories of S (spoofing), T (tampering), R (repudiation), D (denial of service), and E (elevation of privilege), where the T and D categories are applicable for the process 908 and S, R, or E categories are applicable to the node 906. A graphical indicator 910 (“Valid Drawing”) can indicate whether the current threat model graph 902 displayed in the graphical user interface 900 describes a valid threat model for a target system. The validation of the threat model graph 902 can be determined by a validation process, which can be performed in real-time or periodically as a background process (e.g., validation is updated as the threat model graph 902 is modified).

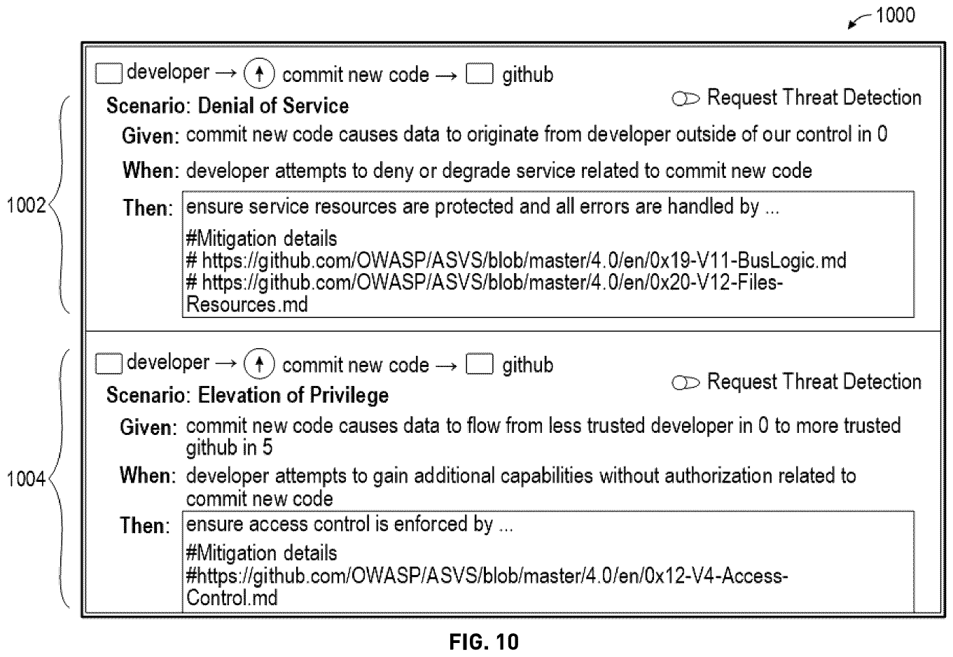

FIG. 10 illustrates an example graphical user interface 1000 presented by a machine learning-based context-aware threat modeling system for reviewing a set of threat scenarios generated in an initial threat model, according to some example embodiments of the present disclosure. As shown, the set of threat scenarios includes a first threat scenario 1002 and a second threat scenario 1004, where each threat scenario is listed with details, such a data flow, a process, and entities (e.g., data flow details 1006) associated with a threat scenario, a threat scenario category (e.g., threat scenario category 1008) associated with a threat scenario, details regarding assumptions (e.g., one or more threat scenario assumptions 1010) and conditions (e.g., one or more threat scenario conditions 1012) for a threat scenario, and a preliminary (e.g., shell or “empty”) mitigation strategy (e.g., mitigation strategy 1014) for a threat scenario. The details provided in the mitigation strategy 1014 of the first threat scenario 1002 represent an example of initial mitigation details (of an initial or template threat model) prior to any mitigation label being included or inserted into the initial threat model.

FIG. 11 illustrates an example graphical user interface 1100 presented by a machine learning-based context-aware threat modeling system for reviewing a set of threat scenarios of a threat model with specific mitigation labels included or inserted, according to some example embodiments of the present disclosure. As shown, the set of threat scenarios includes a first threat scenario 1102 and a second threat scenario 1104, where each threat scenario is listed with details, such a data flow, a process, and entities (e.g., data flow details 1106) associated with a threat scenario, a threat scenario category (e.g., threat scenario category 1108) associated with a threat scenario, details regarding assumptions (e.g., one or more threat scenario assumptions 1110) and conditions (e.g., one or more threat scenario conditions 1112) for a threat scenario, and a preliminary (e.g., shell or “empty”) mitigation strategy (e.g., mitigation strategy 1114 for a threat scenario. The details provided in the mitigation strategy 1114 of the first threat scenario 1102 represent an example of mitigation details (of an initial or template threat model) after one or more specific mitigation labels being included or inserted into the initial threat model for the first threat scenario 1102.

FIG. 12 illustrates a diagrammatic representation of a machine 1200 in the form of a computer system within which a set of instructions can be executed for causing the machine 1200 to perform any one or more of the methodologies discussed herein, according to some example embodiments of the present disclosure. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein can be executed. For example, the instructions 1210 may cause the machine 1200 to execute any one or more operations of any one or more of the methods described herein. As another example, the instructions 1210 may cause the machine 1200 to implement portions of the data flows described herein. In this way, the instructions 1210 transform a general, non-programmed machine into a particular machine 1200 (e.g., the compute service manager 206, the execution platform 208, client device 212) that is specially configured to carry out any one of the described and illustrated functions in the manner described herein.

In alternative embodiments, the machine 1200 operates as a standalone device or can be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines machine 1200 that individually or jointly execute the instructions 1210 to perform any one or more of the methodologies discussed herein.

The machine 1200 includes processors 1204, memory 1212, and input/output (I/O) components 1222 configured to communicate with each other such as via a bus 1202. In an example embodiment, the processors 1204 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1206 and a processor 1208 that may execute the instructions 1210. The term “processor” is intended to include multi-core processors 1204 that may comprise two or more independent processors (sometimes referred to as “cores”) that may execute instructions 1210 contemporaneously. Although FIG. 12 shows multiple processors 1204, the machine 1200 may include a single processor with a single core, a single processor with multiple cores (e.g., a multi-core processor), multiple processors with a single core, multiple processors with multiple cores, or any combination thereof.

The memory 1212 may include a main memory 1214, a static memory 1216, and a storage unit 1218, all accessible to the processors 1204 such as via the bus 1202. The main memory 1214, the static memory 1216, and the storage unit 1218 comprising a machine storage medium 1220 may store the instructions 1210 embodying any one or more of the methodologies or functions described herein. The instructions 1210 may also reside, completely or partially, within the main memory 1214, within the static memory 1216, within the storage unit 1218, within at least one of the processors 1204 (e.g., within the processor's cache memory), or any suitable combination thereof, during execution thereof by the machine 1200.

The I/O components 1222 include components to receive input, provide output, produce output, transmit information, exchange information, capture measurements, and so on. The specific I/O components 1222 that are included in a particular machine 1200 will depend on the type of machine. For example, portable machines such as mobile phones will likely include a touch input device or other such input mechanisms, while a headless server machine will likely not include such a touch input device. It will be appreciated that the I/O components 1222 may include many other components that are not shown in FIG. 12. The I/O components 1222 are grouped according to functionality merely for simplifying the following discussion and the grouping is in no way limiting. In various example embodiments, the I/O components 1222 may include output components 1224 and input components 1226. The output components 1224 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication can be implemented using a wide variety of technologies. The I/O components 1222 may include communication components 1228 operable to couple the machine 1200 to a network 1232 via a coupling 1236 or to devices 1230 via a coupling 1234. For example, the communication components 1228 may include a network interface component or another suitable device to interface with the network 1232. In further examples, the communication components 1228 may include wired communication components, wireless communication components, cellular communication components, and other communication components to provide communication via other modalities. The devices 1230 can be another machine or any of a wide variety of peripheral devices (e.g., a peripheral device coupled via a universal serial bus (USB)). For example, as noted above, the machine 1200 may correspond to any client device, the compute service manager 206, the execution platform 208, and the devices 1230 may include any other of these systems and devices.

The various memories (e.g., 1212, 1214, 1216, and/or memory of the processor(s) 1204 and/or the storage unit 1218) may store one or more sets of instructions 1210 and data structures (e.g., software) embodying or utilized by any one or more of the methodologies or functions described herein. These instructions 1210, when executed by the processor(s) 1204, cause various operations to implement the disclosed embodiments.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1232 can be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1232 or a portion of the network 1232 may include a wireless or cellular network, and the coupling 1236 can be a Code Division Multiple Access (CDMA) connection, a Global System for Mobile communications (GSM) connection, or another type of cellular or wireless coupling. In this example, the coupling 1236 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1210 can be transmitted or received over the network 1232 using a transmission medium via a network interface device (e.g., a network interface component included in the communication components 1228) and utilizing any one of a number of well-known transfer protocols (e.g., hypertext transfer protocol (HTTP)). Similarly, the instructions 1210 can be transmitted or received using a transmission medium via the coupling 1234 (e.g., a peer-to-peer coupling) to the devices 1230. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions 1210 for execution by the machine 1200, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a threat modeling system comprising: at least one hardware processor; and at least one memory storing instructions that cause the at least one hardware processor to perform operations comprising: receiving a threat model graph of a target system being analyzed, the threat model graph comprising a plurality of nodes and a set of edges, each node of the plurality of nodes representing a different entity of the target system, each edge of the set of edges being associated with a different process-related data flow between two nodes of the threat model graph; generating a set of threat models for the target system based on the threat model graph, a select threat model of the set of threat models comprising a data object that uses a structured natural language to describe a set of applicable threat scenarios for the target system and to describe a set of mitigation strategies for the set of applicable threat scenarios; and for an individual threat scenario described in the select threat model: determining a set of generic mitigation labels for the individual threat scenario using a plurality of machine learning models, the using of the plurality of machine learning models comprising inputting the individual threat scenario into each individual machine learning model of the plurality of machine learning models, each individual machine learning model of the plurality of machine learning models being configured to output a determination of whether to include, an individual generic mitigation label associated with the individual machine learning model in a respective threat model received as input by the individual machine learning model; generating a prompt based on a set of inputs that comprises the set of generic mitigation labels; and using a set of large language models to generate a set of specific mitigation labels recommended for the individual threat scenario based on the prompt.

In Example 2, the subject matter of Example 1 includes, wherein the generating the set of threat models based on the threat model graph comprises: generating one or more threat models for each individual process-related data flow between two nodes of the plurality of nodes.

In Example 3, the subject matter of Example 2 includes, wherein the generating of the one or more threat models for each individual process-related data flow between two nodes of the plurality of nodes comprises: using a threat scenario analysis system to analyze the individual process-related data flow and generate the one or more threat models for the individual process-related data flow based on the analysis.

In Example 4, the subject matter of Examples 1-3 includes, wherein the threat model graph is received from a user, and wherein the operations comprise: causing at least some portion of the set of specific mitigation labels to be presented for approval by the user.

In Example 5, the subject matter of Examples 1-4 includes, wherein the threat model graph is received from a user, and wherein the operations comprise: receiving a set of acceptances for one or more mitigation labels of the set of specific mitigation labels; and based on the set of acceptances, causing the one or more mitigation labels to be included in the individual threat model in association with the individual threat scenario.

In Example 6, the subject matter of Example 5 includes, wherein at least one acceptance of the set of acceptances comprises a modification to at least one specific mitigation label of the one or more specific mitigation labels to be included in the individual threat model in association with the individual threat scenario.

In Example 7, the subject matter of Example 6 includes, wherein the operations comprise: storing the modification as part of updated training data; and training at least one machine learning model of the plurality of machine learning models based on the updated training data.

In Example 8, the subject matter of Examples 1-7 includes, wherein the determining of the set of generic mitigation labels using the plurality of machine learning models comprises:
inputting a list of nodes of the threat model graph into each individual machine learning model of the plurality of machine learning models.

In Example 9, the subject matter of Examples 1-8 includes, wherein the determining of the set of generic mitigation labels using the plurality of machine learning models comprises:
inputting data describing at least a portion of a threat scenario analysis methodology into each individual machine learning model of the plurality of machine learning models, the threat scenario analysis methodology being used to analyze the threat model graph to generate the select threat model.

In Example 10, the subject matter of Examples 1-9 includes, wherein the determining of the set of generic mitigation labels using the plurality of machine learning models comprises: inputting data describing a prototyping methodology into each individual machine learning model of the plurality of machine learning models, the prototyping methodology being used to analyze the threat model graph to generate the select threat model.

In Example 11, the subject matter of Examples 1-10 includes, wherein the set of inputs comprises a set of node definitions for one or more nodes of the plurality of nodes of the threat model graph.

In Example 12, the subject matter of Example 11 includes, wherein the plurality of nodes comprises a select node for a select entity of the target system, and wherein the operations comprise: generating the set of node definitions, the generating of the set of node definitions comprising generating a node definition for the select node by matching the select entity to an existing node definition.

In Example 13, the subject matter of Examples 11-12 includes, wherein the plurality of nodes comprises a select node for a select entity of the target system, and wherein the operations comprise: generating the set of node definitions, the generating of the set of node definitions comprising requesting a node definition for the select node from a user.

In Example 14, the subject matter of Examples 11-13 includes, wherein the plurality of nodes comprises a select node for a select entity of the target system, and wherein the operations comprise: generating the set of node definitions, the generating of the set of node definitions comprising generating a node definition for the select node using a machine learning model.

In Example 15, the subject matter of Examples 1-14 includes, wherein the set of inputs comprises a set of security guidelines.

In Example 16, the subject matter of Examples 1-15 includes, wherein an output by the individual machine learning model of the plurality of machine learning models comprises a confidence score for the determination.

In Example 17, the subject matter of Example 16 includes, wherein the determining of the set of generic mitigation labels using the plurality of machine learning models comprises:
determining the set of generic mitigation labels from a plurality of determinations outputs by the plurality of machine learning models based on a confidence score threshold.

In Example 18, the subject matter of Examples 1-17 includes, wherein at least one machine learning model of the plurality of machine learning models is trained on one or more existing threat models.

Example 19 is a method to implement any of Examples 1-18.

Example 20 is a machine-storage medium storing instructions that when executed by a machine, cause the machine to perform operations to implement any of Examples 1-18.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various example embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various example embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A threat modeling system comprising:
at least one hardware processor; and
at least one memory storing instructions that cause the at least one hardware processor to perform operations comprising:
receiving a threat model graph of a target system being analyzed, the threat model graph comprising a plurality of nodes and a set of edges, each node of the plurality of nodes representing a different entity of the target system, each edge of the set of edges being associated with a different process-related data flow between two nodes of the threat model graph;
generating a set of threat models for the target system based on the threat model graph, a select threat model of the set of threat models comprising a data object that uses a structured natural language to describe a set of applicable threat scenarios for the target system and to describe a set of mitigation strategies for the set of applicable threat scenarios; and
for an individual threat scenario described in the select threat model:
determining a set of generic mitigation labels for the individual threat scenario using a plurality of machine learning models, the using of the plurality of machine learning models comprising inputting the individual threat scenario into each individual machine learning model of the plurality of machine learning models, each individual machine learning model of the plurality of machine learning models being configured to output a determination of whether to include an individual generic mitigation label associated with the individual machine learning model in a respective threat model received as input by the individual machine learning model;
generating a prompt based on a set of inputs that comprises the set of generic mitigation labels; and
using a set of large language models to generate a set of specific mitigation labels recommended for the individual threat scenario based on the prompt.

2. The threat modeling system of claim 1, wherein the generating the set of threat models based on the threat model graph comprises:
generating one or more threat models for each individual process-related data flow between two nodes of the plurality of nodes.

3. The threat modeling system of claim 2, wherein the generating of the one or more threat models for each individual process-related data flow between two nodes of the plurality of nodes comprises:
using a threat scenario analysis system to analyze the individual process-related data flow and generate the one or more threat models for the individual process-related data flow based on the analysis.

4. The threat modeling system of claim 1, wherein the threat model graph is received from a user, and wherein the operations comprise:
causing at least some portion of the set of specific mitigation labels to be presented for approval by the user.

5. The threat modeling system of claim 1, wherein the threat model graph is received from a user, and wherein the operations comprise:
receiving a set of acceptances for one or more mitigation labels of the set of specific mitigation labels; and
based on the set of acceptances, causing the one or more mitigation labels to be included in the individual threat model in association with the individual threat scenario.

6. The threat modeling system of claim 5, wherein at least one acceptance of the set of acceptances comprises a modification to at least one specific mitigation label of the one or more specific mitigation labels to be included in the individual threat model in association with the individual threat scenario.

7. The threat modeling system of claim 6, wherein the operations comprise:
storing the modification as part of updated training data; and
training at least one machine learning model of the plurality of machine learning models based on the updated training data.

8. The threat modeling system of claim 1, wherein the determining of the set of generic mitigation labels using the plurality of machine learning models comprises:
inputting a list of nodes of the threat model graph into each individual machine learning model of the plurality of machine learning models.

9. The threat modeling system of claim 1, wherein the determining of the set of generic mitigation labels using the plurality of machine learning models comprises:
inputting data describing at least a portion of a threat scenario analysis methodology into each individual machine learning model of the plurality of machine learning models, the threat scenario analysis methodology being used to analyze the threat model graph to generate the select threat model.

10. The threat modeling system of claim 1, wherein the determining of the set of generic mitigation labels using the plurality of machine learning models comprises:
inputting data describing a prototyping methodology into each individual machine learning model of the plurality of machine learning models, the prototyping methodology being used to analyze the threat model graph to generate the select threat model.

11. The threat modeling system of claim 1, wherein the set of inputs comprises a set of node definitions for one or more nodes of the plurality of nodes of the threat model graph.

12. The threat modeling system of claim 11, wherein the plurality of nodes comprises a select node for a select entity of the target system, and wherein the operations comprise:
generating the set of node definitions, the generating of the set of node definitions comprising generating a node definition for the select node by matching the select entity to an existing node definition.

13. The threat modeling system of claim 11, wherein the plurality of nodes comprises a select node for a select entity of the target system, and wherein the operations comprise:
generating the set of node definitions, the generating of the set of node definitions comprising requesting a node definition for the select node from a user.

14. The threat modeling system of claim 11, wherein the plurality of nodes comprises a select node for a select entity of the target system, and wherein the operations comprise:
generating the set of node definitions, the generating of the set of node definitions comprising generating a node definition for the select node using a machine learning model.

15. The threat modeling system of claim 1, wherein the set of inputs comprises a set of security guidelines.

16. The threat modeling system of claim 1, wherein an output by the individual machine learning model of the plurality of machine learning models comprises a confidence score for the determination.

17. The threat modeling system of claim 16, wherein the determining of the set of generic mitigation labels using the plurality of machine learning models comprises:
determining the set of generic mitigation labels from a plurality of determinations outputs by the plurality of machine learning models based on a confidence score threshold.

18. The threat modeling system of claim 1, wherein at least one machine learning model of the plurality of machine learning models is trained on one or more existing threat models.

19. A method comprising:
receiving, by at least one processor, a threat model graph of a target system being analyzed, the threat model graph comprising a plurality of nodes and a set of edges, each node of the plurality of nodes representing a different entity of the target system, each edge of the set of edges being associated with a different process-related data flow between two nodes of the threat model graph;
generating, by the at least one processor, a set of threat models for the target system based on the threat model graph, a select threat model of the set of threat models comprising a data object that uses a structured natural language to describe a set of applicable threat scenarios for the target system and to describe a set of mitigation strategies for the set of applicable threat scenarios; and
for an individual threat scenario described in the select threat model:
determining, by the at least one processor, a set of generic mitigation labels for the individual threat scenario using a plurality of machine learning models, the using of the plurality of machine learning models comprising inputting the individual threat scenario into each individual machine learning model of the plurality of machine learning models, each individual machine learning model of the plurality of machine learning models being configured to output a determination of whether to include an individual generic mitigation label associated with the individual machine learning model in a respective threat model received as input by the individual machine learning model;
generating, by the at least one processor, a prompt based on a set of inputs that comprises the set of generic mitigation labels; and
using, by the at least one processor, a set of large language models to generate a set of specific mitigation labels recommended for the individual threat scenario based on the prompt.

20. The method of claim 19, wherein the generating the set of threat models based on the threat model graph comprises:
generating one or more threat models for each individual process-related data flow between two nodes of the plurality of nodes.

21. The method of claim 20, wherein the generating of the one or more threat models for each individual process-related data flow between two nodes of the plurality of nodes comprises:
using a threat scenario analysis system to analyze the individual process-related data flow and generate the one or more threat models for the individual process-related data flow based on the analysis.

22. The method of claim 19, wherein the threat model graph is received from a user, and wherein the method comprises:
causing the set of specific mitigation labels to be presented for approval by the user.

23. The method of claim 19, wherein the threat model graph is received from a user, and wherein the method comprises:
receiving a set of acceptances for one or more mitigation labels of the set of specific mitigation labels; and
based on the set of acceptances, causing the one or more mitigation labels to be included in the select threat model in association with the individual threat scenario.

24. The method of claim 23, wherein at least one acceptance of the set of acceptances comprises a modification to at least one specific mitigation label of the one or more specific mitigation labels to be included in the select threat model in association with the individual threat scenario.

25. The method of claim 24, wherein the method comprises:
storing the modification as part of updated training data; and
training at least one machine learning model of the plurality of machine learning models based on the updated training data.

26. A machine-storage medium storing instructions that when executed by a machine, cause the machine to perform operations comprising:
receiving a threat model graph of a target system being analyzed, the threat model graph comprising a plurality of nodes and a set of edges, each node of the plurality of nodes representing a different entity of the target system, each edge of the set of edges being associated with a different process-related data flow between two nodes of the threat model graph;
generating a set of threat models for the target system based on the threat model graph, a select threat model of the set of threat models comprising a data object that uses a structured natural language to describe a set of applicable threat scenarios for the target system and to describe a set of mitigation strategies for the set of applicable threat scenarios; and
for an individual threat scenario described in the select threat model:
determining a set of generic mitigation labels for the individual threat scenario using a plurality of machine learning models, the using of the plurality of machine learning models comprising inputting the individual threat scenario into each individual machine learning model of the plurality of machine learning models, each individual machine learning model of the plurality of machine learning models being configured to output a determination of whether to include an individual generic mitigation label associated with the individual machine learning model in a respective threat model received as input by the individual machine learning model;
generating a prompt based on a set of inputs that comprises the set of generic mitigation labels; and
using a set of large language models to generate a set of specific mitigation labels recommended for the individual threat scenario based on the prompt.
